(19) United States
(12) Patent Application Publication
(10) Pub. No.: US 2024/0250266 A1
(43) Pub. Date: Jul. 25, 2024

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Yuki YOSHIMURA, Kyoto (JP)

(21) Appl. No.: 18/441,150

(22) Filed: Feb. 14, 2024

Related U.S. Application Data
(63) Continuation of application No. PCT/JP2022/036989, filed on Oct. 3, 2022.

(30) Foreign Application Priority Data
Oct. 5, 2021 (JP) 2021-163986

(51) Int. Cl. H01M 4/62; H01M 4/02; H01M 10/0525

(52) U.S. Cl. CPC H01M 4/622; H01M 10/0525; H01M 2004/027

(57) ABSTRACT

A secondary battery includes a positive electrode, a negative electrode, and an electrolytic solution. The negative electrode includes a polyrotaxane and an organic fiber compound.

### CROSS REFERENCE TO RELATED APPLICATIONS

The present application is a continuation of PCT patent application no. PCT/JP2022/036989, filed on Oct. 3, 2022, which claims priority to Japanese patent application no. 2021-163986, filed on Oct. 5, 2021, the entire contents of which are incorporated herein by reference.

### BACKGROUND

The present technology relates to a negative electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode (a negative electrode for a secondary battery), and an electrolytic solution. A configuration of the secondary battery has been considered in various ways.

Specifically, in order to achieve a superior cyclability characteristic, a polymer compound including cyclic molecules and a linear polymer molecule is used as a binder for a negative electrode. In the polymer compound, a linear polymer penetrates each of the cyclic molecules.

### SUMMARY

The present technology relates to a negative electrode for a secondary battery, and a secondary battery.

Although consideration has been given in various ways regarding a configuration of a secondary battery, a low-temperature cyclability characteristic and a load characteristic are each not sufficient yet. Accordingly, there is room for improvement in terms thereof.

It is therefore desirable to provide a negative electrode for a secondary battery, and a secondary battery that each make it possible to achieve a superior low-temperature cyclability characteristic and a superior load characteristic.

A negative electrode for a secondary battery according to an embodiment of the present technology includes a polyrotaxane and an organic fiber compound.

A secondary battery according to an embodiment of the present technology includes a positive electrode, a negative electrode, and an electrolytic solution. The negative electrode has a configuration similar to the configuration of the negative electrode for a secondary battery according to an embodiment of the present technology described above.

Here, the “polyrotaxane” is a molecular aggregate (a polymer compound) including a cyclic molecule and a linear molecule. The linear molecule penetrates the cyclic molecule, and has an end group that serves as a steric hindrance to the cyclic molecule at each of opposite ends. Note that, for example, a configuration and a kind of the polyrotaxane will be described in detail later.

According to the negative electrode for a secondary battery or the secondary battery of an embodiment of the present technology, the negative electrode for a secondary battery includes the polyrotaxane and the organic fiber compound. Accordingly, it is possible to achieve a superior low-temperature cyclability characteristic and a superior load characteristic.

Note that effects of the present technology are not necessarily limited to those described herein and may include any of a series of suitable effects in relation to the present technology.

### BRIEF DESCRIPTION OF THE FIGURES

FIG. 1 is a sectional view of a configuration of a negative electrode for a secondary battery according to an embodiment of the present technology.

FIG. 2 is an enlarged sectional view of a configuration of a negative electrode active material particle in a negative electrode for a secondary battery according to an embodiment of the present technology.

FIG. 3 is a perspective view of a configuration of a secondary battery according to an embodiment of the present technology.

FIG. 4 is a sectional view of a configuration of a battery device illustrated in FIG. 3.

FIG. 5 is a block diagram illustrating a configuration of an application example of the secondary battery.

### DETAILED DESCRIPTION

The present technology will be described below in further detail including with reference to the drawings according to an embodiment.

A description is given first of a negative electrode for a secondary battery (hereinafter, simply referred to as a “negative electrode”) according to an embodiment of the present technology.

The negative electrode is to be used in a secondary battery, which is an electrochemical device. However, the negative electrode may be used in electrochemical devices other than a secondary battery. Other electrochemical devices are not particularly limited in kind, and specific examples thereof include a capacitor.

In the electrochemical device such as the secondary battery, an electrode reactant is to be inserted into and extracted from the negative electrode upon an electrode reaction. The electrode reactant is not particularly limited in kind, and specific examples thereof include a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. That is, lithium is inserted into and extracted from the negative electrode in an ionic state upon the electrode reaction.

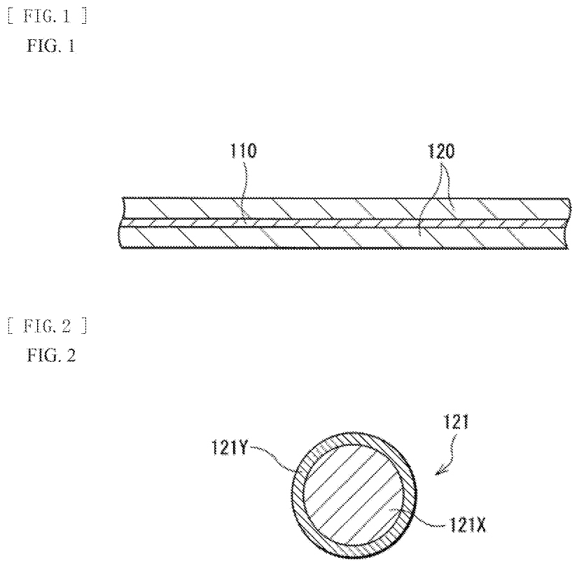

FIG. 1 illustrates a sectional configuration of the negative electrode according to an embodiment. Note that FIG. 1 illustrates only a portion of the negative electrode.

The negative electrode includes a polyrotaxane and an organic fiber compound. Only one polyrotaxane may be used, or two or more polyrotaxanes may be used. Similarly, only one organic fiber compound may be used, or two or more organic fiber compounds may be used.

More specifically, as illustrated in FIG. 1, the negative electrode includes a negative electrode current collector 110 and a negative electrode active material layer 120. The negative electrode active material layer 120 includes the polyrotaxane and the organic fiber compound, which are mentioned above. In this case, the polyrotaxane and the organic fiber compound are each dispersed in the negative electrode active material layer 120.

A reason why the negative electrode active material layer 120 includes the polyrotaxane and the organic fiber compound, and the polyrotaxane and the organic fiber compound are each dispersed in the negative electrode active material layer 120 is that synergistic interaction between the polyrotaxane and the organic fiber compound suppresses collapse of the negative electrode active material layer 120 and a decomposition reaction of an electrolytic solution to be described later, while securing ion conductivity of lithium.

In more detail, when the negative electrode active material layer 120 includes both the polyrotaxane and the organic fiber compound, advantages described below are obtainable, unlike when the negative electrode active material layer 120 does not include either the polyrotaxane or the organic fiber compound or includes neither the polyrotaxane nor the organic fiber compound.

Firstly, the polyrotaxane forms a film including the organic fiber compound as a core on a surface of a negative electrode active material to be described later, and the film reinforces the surface of the negative electrode active material. Thus, the film is used to improve physical strength of the negative electrode active material, which prevents the negative electrode active material layer 120 from easily collapsing even if the negative electrode active material expands and contracts upon the electrode reaction. In this case, preventing the negative electrode active material layer 120 from easily collapsing prevents the negative electrode active material layer 120 from easily slipping off the negative electrode current collector 110.

Secondly, the surface of the negative electrode active material having reactivity is protected by the film, and the surface of the negative electrode active material is thus separated from the electrolytic solution. This prevents the electrolytic solution from easily reacting with the negative electrode active material, which suppresses the decomposition reaction of the electrolytic solution on the surface of the negative electrode active material.

In this case, in particular, because the surface of the negative electrode active material is reinforced by the film, the negative electrode active material does not easily crack even if the negative electrode active material expands and contracts upon the electrode reaction. This prevents a fresh surface (a reaction active site) of the negative electrode active material having reactivity from being easily formed, which stably suppresses the decomposition reaction of the electrolytic solution even upon repeated electrode reactions.

Thirdly, because the polyrotaxane and the organic fiber compound coexist in the negative electrode active material layer 120, the film is additionally formed even if a portion of the film is decomposed. Thus, the film exhibits a self-healing function, which continuously suppresses the collapse of the negative electrode active material layer 120 and the decomposition reaction of the electrolytic solution.

Fourthly, the organic fiber compound has a porous structure, and the film has a porous structure reflecting the porous structure of the organic fiber compound. Thus, even if the film is formed on the surface of the negative electrode active material, a movement path for lithium ions is secured using the porous structure of the film. As a result, the ion conductivity of the lithium ions is secured, which makes it easier for lithium to be inserted into and extracted from the negative electrode active material.

The negative electrode current collector 110 has two opposed surfaces on each of which the negative electrode active material layer 120 is to be provided. The negative electrode current collector 110 includes any one or more of electrically conductive materials including, without limitation, a metal material. Specific examples of the electrically conductive material include copper, aluminum, nickel, and stainless steel.

The surface of the negative electrode current collector 110 is preferably roughened by a method such as an electrolytic method. A reason for this is that adherence of the negative electrode active material layer 120 to the negative electrode current collector 110 is improved using what is called an anchor effect. Note, however, that the negative electrode current collector 110 may be omitted.

The negative electrode active material layer 120 includes the above-mentioned polyrotaxane and organic fiber compound together with the negative electrode active material which lithium is insertable into and extractable from. Note that the negative electrode active material layer 120 may further include any one or more of other materials including, without limitation, a negative electrode binder and a negative electrode conductor.

Here, the negative electrode active material layer 120 is provided on each of the two opposed surfaces of the negative electrode current collector 110. Note, however, that the negative electrode active material layer 120 may be provided only on one of the two opposed surfaces of the negative electrode current collector 110.

A method of forming the negative electrode active material layer 120 is not particularly limited and specifically includes any one or more of methods including, without limitation, a coating method, a vapor-phase method, a liquid-phase method, a thermal spraying method, and a firing (sintering) method.

The negative electrode active material is not particularly limited in kind and specifically includes any one or more of materials including, without limitation, a carbon material and a metal-based material. That is, the negative electrode active material may include only the carbon material, only the metal-based material, or both of the carbon material and the metal-based material. A reason for this is that a high energy density is obtainable. However, the kind of the negative electrode active material may be any material other than the carbon material and the metal-based material.

The term “carbon material” is a generic term for a material including carbon as a constituent element. A reason for this is that a high energy density is stably obtainable owing to a crystal structure of the carbon material that hardly varies upon insertion and extraction of lithium. Another reason is that improved electrical conductivity of the negative electrode active material layer 120 is achievable owing to the carbon material that also serves as the negative electrode conductor.

Specific examples of the carbon material include graphitizable carbon, non-graphitizable carbon, and graphite (natural graphite and artificial graphite). Spacing of a (002) plane of the non-graphitizable carbon is not particularly limited and is specifically greater than or equal to 0.37 nm. Spacing of a (002) plane of the graphite is not particularly limited and is specifically less than or equal to 0.34 nm.

Specific examples of the carbon material also include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a resultant of firing or carbonizing a polymer compound such as a phenol resin or a furan resin at an appropriate temperature. Other than the above, the carbon material may be low-crystalline carbon subjected to heat treatment at a temperature of about 1000° C. or lower, or may be amorphous carbon. The carbon material is not particularly limited in shape, and specific examples thereof include any one or more shapes including, without limitation, a fibrous shape, a spherical shape, a granular shape, and a flaky shape.

The term “metal-based material” is a generic term for a material that includes, as one or more constituent elements, any one or more elements among metal elements and metalloid elements that are each able to form an alloy with lithium. A reason for this is that a higher energy density is obtainable.

The metal-based material may be a simple substance, an alloy, a compound, a mixture of two or more thereof, or a material including one or more phases thereof. The “simple substance” described here merely refers to a simple substance in a general sense. The simple substance may therefore include a small amount of impurity. That is, purity of the simple substance does not necessarily have to be 100%.

Note, however, that the term “alloy” described here includes not only a material including two or more metal elements as constituent elements, but also a material including one or more metal elements and one or more metalloid elements as constituent elements. Additionally, the term “alloy” may further include one or more non-metallic elements as one or more constituent elements. The metal-based material is not particularly limited in state, but specifically includes any one or more states including, without limitation, a solid solution, a eutectic (a eutectic mixture), an intermetallic compound, and a state including two or more thereof that coexist.

Specific examples of the metal element and the metalloid element include magnesium, boron, aluminum, gallium, indium, silicon, germanium, tin, lead, bismuth, cadmium, silver, zinc, hafnium, zirconium, yttrium, palladium, and platinum.

Among these elements, silicon is preferable. A reason for this is that a markedly high energy density is obtainable owing to superior lithium insertability and superior lithium extractability of silicon.

The silicon alloy includes any one or more of metal elements including, without limitation, tin, nickel, copper, iron, cobalt, manganese, zinc, indium, silver, titanium, germanium, bismuth, antimony, and chromium as one or more constituent elements other than silicon. The silicon compound includes any one or more of non-metallic elements including, without limitation, carbon and oxygen as one or more constituent elements other than silicon. Note, however, that the silicon compound may include, as one or more constituent elements other than silicon, any one or more of the series of metal elements described in relation to the silicon alloy.

Specific examples of the silicon alloy include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, and SiC. Note, however, that a composition of the silicon alloy (a mixture ratio between silicon and the metal element) may be changed as desired.

Specific examples of the silicon compound include Si₃N₄, Si₂N₂O, SiOₓ (where 0<x≤2), and LiSiO. Note, however, that a range of “x” may be 0.2<x<1.4.

In particular, the negative electrode active material preferably includes both the carbon material and the metal-based material for reasons described below.

While the metal-based material, in particular, a material including silicon as a constituent element has an advantage of having a high theoretical capacity, there is a concern that it easily expands and contracts greatly upon charging and discharging. While there is a concern that the carbon material has a low theoretical capacity, the carbon material has an advantage that it resists expanding and contracting upon charging and discharging. Thus, the combined use of the carbon material and the metal-based material suppresses expanding and contracting of the negative electrode active material layer 120 upon charging and discharging while achieving a high theoretical capacity (that is, a high battery capacity).

The polyrotaxane is a molecular assembly (a polymer compound) including a cyclic molecule and a linear molecule, as described above. The linear molecule penetrates the cyclic molecule, and has an end group that serves as a steric hindrance to the cyclic molecule at each of opposite ends. Note that the linear molecule is referred to as an axial molecule in some cases. The polyrotaxane may include multiple cyclic molecules. The polyrotaxane may include multiple linear molecules.

The cyclic molecule is a molecule having a cyclic structure and having a hole through which the linear molecule is to be placed. The cyclic molecule is not particularly limited in kind and specifically includes any one or more of materials including, without limitation, a cyclodextrin, a crown ether, a thiocrown ether, a cyclophane, a calixarene, a thiocalixarene, a cucurbituril, a pillararene, and a cyclic amide. A reason for this is that this makes it easier for the film derived from the polyrotaxane and the organic fiber compound to be formed stably.

The linear molecule is a molecule that has a rod-shaped structure and is placed through the hole (a ring) provided in the cyclic molecule. The linear molecule penetrates the cyclic molecule, and has the end group that serves as a steric hindrance to the cyclic molecule at each of the opposite ends, as described above. A reason for this is that the end group serves as what is called a stopper, and the steric hindrance resulting from the presence of the end group is used to prevent the cyclic molecule from easily becoming detached from the linear molecule.

The linear molecule is not particularly limited in kind, and specifically includes any one or more of polyethylene glycol, polyoxymethylene, polypropylene oxide, polyvinyl alcohol, polyvinylidene difluoride, a straight-chain alkane, an amide, or ammonium. A reason for this is that this makes it easier for the film derived from the polyrotaxane and the organic fiber compound to be formed stably.

The end group is not particularly limited in kind as long as the end group is any one or more of bulky groups that are each able to bond to a functional group present at the end of the linear molecule. Specific examples of the end group include a dinitrophenyl group, a cyclodextrin group, an adamantyl group, a trityl group, a fluoresceinyl group, a pyrenyl group, and an anthracenyl group. In addition, the end group may be a main chain or a side chain of a polymer compound having a number-average molecular weight within a range from 1,000 to 1,000,000 both inclusive. A reason for this is that this sufficiently prevents the cyclic molecule from easily becoming detached from the linear molecule, which makes it easier for the film to be formed more stably. The linear molecule has the end group introduced at each of the opposite ends.

The organic fiber compound is a fibrous polymer compound (carbohydrate) and may include, as one or more constituent elements, any one or more of non-carbon elements including, without limitation, nitrogen.

The organic fiber compound is not particularly limited in kind and specifically includes any one or more of cellulose, chitin, or chitosan. A reason for this is that this makes it easier for the film derived from the polyrotaxane and the organic fiber compound to be formed stably.

The negative electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The negative electrode conductor includes any one or more of electrically conductive materials including, without limitation, a carbon material. The carbon material may be a particulate carbon material, a fibrous carbon material, or both. Specific examples of the particulate carbon material include graphite, carbon black, acetylene black, and Ketjen black. Specific examples of the fibrous carbon material include carbon nanotubes and carbon fibers. Note, however, that the electrically conductive material is not limited to the carbon material, and may be a metal material or a polymer compound, for example.

In particular, the negative electrode conductor preferably includes the fibrous carbon material. A reason for this is that improved electron conductivity between the negative electrode active materials reduces electric resistance of the negative electrode active material layer 120.

In manufacturing the negative electrode, first, the negative electrode active material, the polyrotaxane, and the organic fiber compound are mixed with each other to thereby obtain a negative electrode mixture. In this case, the negative electrode mixture may include, for example, the negative electrode binder or the negative electrode conductor on an as-needed basis.

Thereafter, the negative electrode mixture is put into a solvent to thereby prepare a negative electrode mixture slurry in paste form. The solvent may be an aqueous solvent, or may be an organic solvent. In this case, the solvent with the negative electrode mixture put thereinto may be stirred using a stirring apparatus such as a mixer.

Lastly, the negative electrode mixture slurry is applied on the two opposed surfaces of the negative electrode current collector 110 to thereby form the negative electrode active material layers 120. Thereafter, the negative electrode active material layers 120 may be compression-molded by means of, for example, a roll pressing machine. In this case, the negative electrode active material layers 120 may be heated. The negative electrode active material layers 120 may be compression-molded multiple times.

In this manner, the negative electrode active material layers 120 are formed on the respective two opposed surfaces of the negative electrode current collector 110. Thus, the negative electrode is completed.

The negative electrode of an embodiment includes the polyrotaxane and the organic fiber compound.

In this case, as described above, because the polyrotaxane forms the film including the organic fiber compound as a core on the surface of the negative electrode active material, the synergistic interaction between the polyrotaxane and the organic fiber compound suppresses the collapse of the negative electrode active material layer 120 and the decomposition reaction of the electrolytic solution while securing the ion conductivity of lithium.

Accordingly, it is possible for the secondary battery including the negative electrode to achieve a superior low-temperature cyclability characteristic and a superior electric resistance characteristic.

In particular, the organic fiber compound may include any one or more of cellulose, chitin, or chitosan. This helps to sufficiently improve the ion conductivity of lithium and to sufficiently suppress each of the collapse of the negative electrode active material layer 120 and the decomposition reaction of the electrolytic solution. This makes it possible to achieve higher effects.

Further, the polyrotaxane may include the cyclic molecule and the linear molecule (the end group), the cyclic molecule may include any one or more of a cyclodextrin, a crown ether, a thiocrown ether, a cyclophane, a calixarene, a thiocalixarene, a cucurbituril, a pillararene, or a cyclic amide, the linear molecule may include any one or more of polyethylene glycol, polyoxymethylene, polypropylene oxide, polyvinyl alcohol, polyvinylidene difluoride, a straight-chain alkane, an amide, or ammonium, and the end group may include any one or more of a dinitrophenyl group, a cyclodextrin group, an adamantyl group, a trityl group, a fluoresceinyl group, a pyrenyl group, or an anthracenyl group. This helps to sufficiently improve the ion conductivity of lithium, and sufficiently suppress each of the collapse of the negative electrode active material layer 120 and the decomposition reaction of the electrolytic solution. This makes it possible to achieve higher effects.

Further, the negative electrode active material layer 120 may include the negative electrode active material, the polyrotaxane, and the organic fiber compound. In this case, the polyrotaxane and the organic fiber compound are each dispersed in the negative electrode active material layer 120. This makes it easier for the film to be sufficiently formed using the polyrotaxane and the organic fiber compound. This makes it possible to achieve higher effects.

A description is given next of a negative electrode for a secondary battery (hereinafter referred to as a “negative electrode”) according to an embodiment of the present technology.

The negative electrode of an embodiment has a configuration similar to that of the negative electrode described above except for a difference in the configuration of the negative electrode active material layer 120 as described below in further detail. In the following, where appropriate, reference will be made to FIG. 1 that has already been described.

FIG. 2 illustrates an enlarged sectional configuration of a negative electrode active material particle 121 in the negative electrode. The negative electrode active material layer 120 includes the negative electrode material in a form of particles (negative electrode active material particles 121), and the negative electrode active material particles 121 each include a center part 121X and a covering part 121Y as illustrated in FIG. 2.

The center part 121X includes any one or more of materials including, without limitation, a carbon material and a metal-based material to allow for insertion and extraction of lithium. Details of each of the carbon material and the metal-based material are as described above.

The covering part 121Y covers a surface of the center part 121X and includes the polyrotaxane and the organic fiber compound. Details of each of the polyrotaxane and the organic fiber compound are as described above. The covering part 121Y may cover the entire surface of the center part 121X, or may cover only a portion of the surface of the center part 121X. In the latter case, multiple covering parts 121Y may cover the surface of the center part 121X at respective locations separate from each other.

That is, in an embodiment, unlike in which the polyrotaxane and the organic fiber compound are each dispersed in the negative electrode active material layer 120, the polyrotaxane and the organic fiber compound are each included in the covering part 121Y. Thus, the polyrotaxane and the organic fiber compound are each localized on the surface of the center part 121X.

When the covering part 121Y of each of the negative electrode active material particle 121 includes the polyrotaxane and the organic fiber compound, advantages similar to those in the first embodiment are obtainable. That is, the synergistic interaction between the polyrotaxane and the organic fiber compound suppresses the collapse of the negative electrode active material layer 120 and the decomposition reaction of the electrolytic solution while securing the ion conductivity of lithium.

In this case, in particular, because the polyrotaxane and the organic fiber compound are each localized on the surface of the center part 121X, it is easier for the film to effectively reinforce and protect the surface of the negative electrode active material, and to effectively exhibit the self-healing function. This further suppresses the collapse of the negative electrode active material layer 120 and the decomposition reaction of the electrolytic solution, compared with the first embodiment in which the polyrotaxane and the organic fiber compound are each not localized on the surface of the negative electrode active material.

The negative electrode active material layer 120 may further include any one or more of other materials including, without limitation, a negative electrode binder and a negative electrode conductor. Details of each of the negative electrode binder and the negative electrode conductor are as described above according to an embodiment.

A method of manufacturing the negative electrode according to an embodiment is similar to the method of manufacturing the negative electrode described above, except for a difference in the forming procedure of the negative electrode active material layer 120.

In forming the negative electrode active material layer 120, first, the center part 121X, the polyrotaxane, and the organic fiber compound are mixed with each other to thereby obtain a mixture. The polyrotaxane and the organic fiber compound are raw materials for forming the covering part 121Y. The center part 121X is in a powder form, and includes any one or more of materials including, without limitation, the carbon material and the metal-based material as described above. Thereafter, the mixture is put into a solvent to thereby prepare a mixed solution. The solvent may be an aqueous solvent, or may be an organic solvent. In this case, the solvent with the mixture put thereinto may be stirred using a stirring apparatus such as a mixer.

Thereafter, the mixed solution is sprayed using a spraying apparatus such as a spray dryer. This forms the covering part 121Y including the polyrotaxane and the organic fiber compound on the surface of the center part 121X. Thus, the negative electrode active material particles 121 are obtainable.

Lastly, as described above, the negative electrode active material particles 121 are used to prepare a negative electrode mixture slurry, following which the negative electrode mixture slurry is used to form the negative electrode active material layer 120.

The negative electrode includes the polyrotaxane and the organic fiber compound. This helps to suppress the collapse of the negative electrode active material layer 120 and the decomposition reaction of the electrolytic solution while securing the ion conductivity of lithium. Accordingly, it is possible for a secondary battery including the negative electrode to achieve a superior low-temperature cyclability characteristic and a superior electric resistance characteristic.

In particular, the covering part 121Y may cover the surface of the center part 121X which lithium is insertable into and extractable from, and the covering part 121Y may include the polyrotaxane and the organic fiber compound. In this case, the polyrotaxane and the organic fiber compound are each localized on the surface of the center part 121X. This helps to further suppress the collapse of the negative electrode active material layer 120 and the decomposition reaction of the electrolytic solution. Accordingly, it is possible to achieve higher effects.

Other action and effects of the negative electrode are similar to those described above according to an embodiment.

A description is given next of a secondary battery according to an embodiment of the present technology including the negative electrode described above.

The secondary battery to be described here is a secondary battery that obtains a battery capacity using insertion and extraction of an electrode reactant, and includes a positive electrode, a negative electrode, and an electrolytic solution, as described above.

In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

Details of the kinds of the electrode reactant are as described above. Examples are given below of a case where the electrode reactant is lithium as in the description given above in relation to the negative electrode. A secondary battery that obtains a battery capacity using insertion and extraction of lithium is what is called a lithium-ion secondary battery. In the lithium-ion secondary battery, lithium is inserted and extracted in an ionic state.

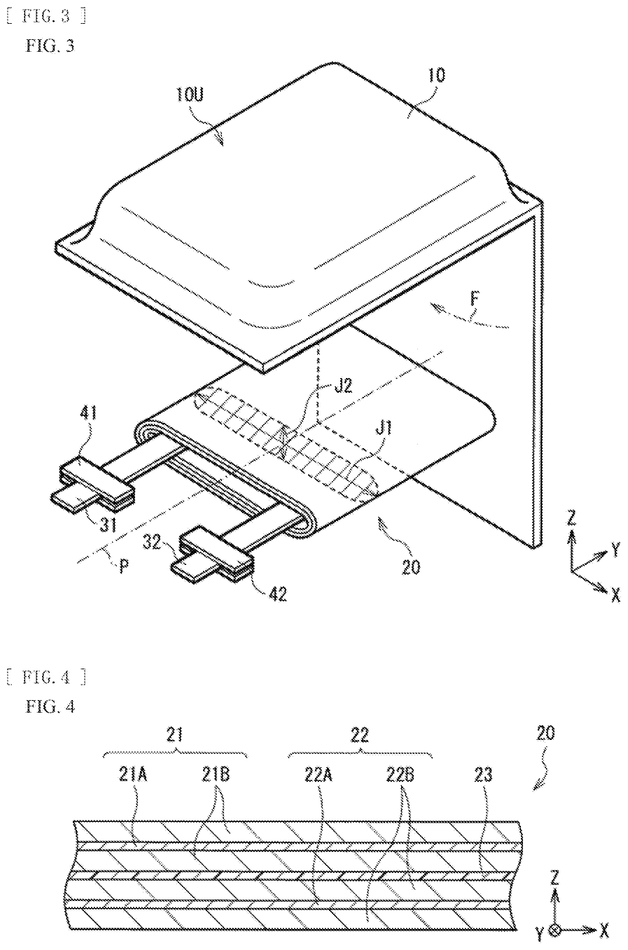

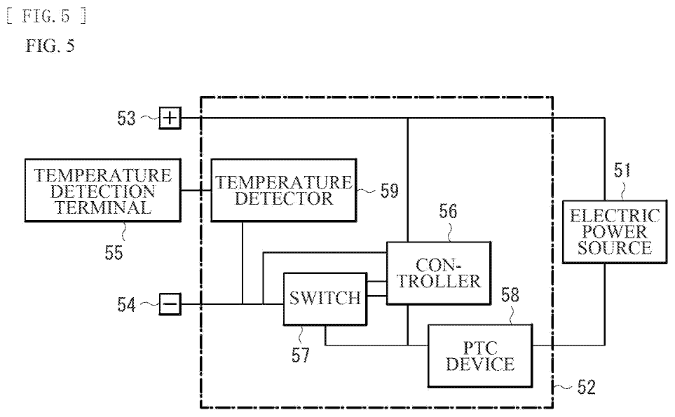

FIG. 3 illustrates a perspective configuration of the secondary battery. FIG. 4 illustrates a sectional configuration of a battery device 20 illustrated in FIG. 3. Note that FIG. 3 illustrates a state where an outer package film 10 and the battery device 20 are separated from each other, and a section of the battery device 20 along an XZ plane is indicated by a dashed line. FIG. 4 illustrates only a portion of the battery device 20.

As illustrated in FIGS. 3 and 4, the secondary battery includes the outer package film 10, the battery device 20, a positive electrode lead 31, a negative electrode lead 32, and sealing films 41 and 42. The secondary battery described here is a secondary battery of a laminated-film type in which an outer package member (the outer package film 10) having flexibility or softness is used.

As illustrated in FIG. 3, the outer package film 10 is the outer package member that contains the battery device 20. The outer package film 10 has a pouch-shaped structure that is sealed in a state where the battery device 20 is contained inside the outer package film 10. The outer package film 10 thus contains a positive electrode 21, a negative electrode 22, and an electrolytic solution that are to be described later.

Here, the outer package film 10 is a single film-shaped member and is folded toward a folding direction F. The outer package film 10 has a depression part 1OU to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 3 and 4, the battery device 20 is a power generation device that includes the positive electrode 21, the negative electrode 22, a separator 23, and the electrolytic solution (not illustrated). The battery device 20 is contained inside the outer package film 10.

The battery device 20 is what is called a wound electrode body. That is, the positive electrode 21 and the negative electrode 22 are stacked on each other with the separator 23 interposed therebetween, and are wound about a winding axis P in a state where the positive electrode 21 and the negative electrode 22 are opposed to each other with the separator 23 interposed therebetween. The winding axis Pis a virtual axis extending in a Y-axis direction.

A three-dimensional shape of the battery device 20 is not particularly limited. Here, the battery device 20 has an elongated shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 4, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

Here, the positive electrode active material layer 21B is provided on each of the two opposed surfaces of the positive electrode current collector 21A. The positive electrode active material layer 21B includes any one or more of positive electrode active materials which lithium is insertable into and extractable from. Note that the positive electrode active material layer 21B may be provided only on one of the two opposed surfaces of the positive electrode current collector 21A on a side where the positive electrode 21 is opposed to the negative electrode 22. Further, the positive electrode active material layer 21B may further include any one or more of other materials including, without limitation, a positive electrode binder and a positive electrode conductor. A method of forming the positive electrode active material layer 21B is not particularly limited and specifically includes any one or more of methods including, without limitation, a coating method.

The positive electrode active material is not particularly limited in kind, and specific examples thereof include a lithium-containing compound. The lithium-containing compound is a compound including lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table of elements. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65} Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

Details of the positive electrode binder are similar to those of the negative electrode binder described above. Details of the positive electrode conductor are similar to those of the negative electrode conductor described above.

The configuration of the negative electrode 22 is similar to that of the negative electrode described above. That is, the negative electrode 22 includes the polyrotaxane and the organic fiber compound. More specifically, the negative electrode 22 includes, as illustrated in FIG. 4, a negative electrode current collector 22A corresponding to the negative electrode current collector 110 and a negative electrode active material layer 22B corresponding to the negative electrode active material layer 120.

The negative electrode 22 may have a configuration similar to that of the negative electrode of the first embodiment or may have a configuration similar to that of the negative electrode of the second embodiment.

As illustrated in FIG. 4, the separator 23 is an insulating porous film interposed between the positive electrode 21 and the negative electrode 22 and allows lithium ions to pass therethrough while preventing contact (a short circuit) between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents), and the electrolytic solution including the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example. A reason for this is that a dissociation property of the electrolyte salt and mobility of ions improve.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is a chain carboxylic acid ester, for example. Specific examples of the chain carboxylic acid ester include ethyl acetate, ethyl propionate, propyl propionate, and ethyl trimethylacetate.

The lactone-based compound is a lactone, for example. Specific examples of the lactone include γ-butyrolactone and γ-valerolactone.

Note that the ether may be the lactone-based compound, 1,2-dimethoxyethane, tetrahydrofuran, 1,3-dioxolane, or 1,4-dioxane, for example.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). A reason for this is that a high battery capacity is obtainable.

A content of the electrolyte salt is not particularly limited and is specifically within a range from 0.3 mol/kg to 3.0 mol/kg both inclusive with respect to the solvent. A reason for this is that high ion conductivity is obtainable.

Note that the electrolytic solution may further include any one or more of additives. The additives are not particularly limited in kind, and specific examples thereof include an unsaturated cyclic carbonic acid ester, a halogenated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the halogenated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

As illustrated in FIGS. 3 and 4, the positive electrode lead 31 is a positive electrode terminal coupled to the positive electrode current collector 21A of the positive electrode 21, and is led from an inside to an outside of the outer package film 10. The positive electrode lead 31 includes an electrically conductive material such as a metal material. Specific examples of the electrically conductive material include aluminum. The positive electrode lead 31 is not particularly limited in shape, and specifically has any of shapes including, without limitation, a thin plate shape and a meshed shape.

As illustrated in FIGS. 3 and 4, the negative electrode lead 32 is a negative electrode terminal coupled to the negative electrode current collector 22A of the negative electrode 22, and is led from the inside to the outside of the outer package film 10. The negative electrode lead 32 includes an electrically conductive material such as a metal material. Specific examples of the electrically conductive material include copper. Details of a direction in which the negative electrode lead 32 is led are similar to those of the direction in which the positive electrode lead 31 is led. Details of a shape of the negative electrode lead 32 are similar to those of the shape of the positive electrode lead 31.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

In manufacturing the secondary battery, the positive electrode 21 and the negative electrode 22 are each fabricated and the electrolytic solution is prepared, following which the secondary battery is assembled using the positive electrode 21, the negative electrode 22, and the electrolytic solution and a stabilization process is performed on the assembled secondary battery, in accordance with an example procedure described below.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Lastly, the positive electrode active material layers 21B may be compression-molded by means of, for example, a roll pressing machine. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. Thus, the positive electrode 21 is fabricated.

The negative electrode active material layers 22B are formed on the respective two opposed surfaces of the negative electrode current collector 22A by a procedure similar to the fabrication procedure of the negative electrode described above to thereby fabricate the negative electrode 22. In this case, a procedure similar to the fabrication procedure of the negative electrode of the first embodiment may be used or a procedure similar to the fabrication procedure of the negative electrode of the second embodiment may be used.

The electrolyte salt is put into a solvent. The electrolyte salt is thereby dispersed or dissolved in the solvent. As a result, the electrolytic solution is prepared.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by a joining method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having the pouch shape.

Lastly, the electrolytic solution is injected into the outer package film 10 having the pouch shape, following which outer edge parts of the remaining one side of the fusion-bonding layer are bonded to each other by a bonding method such as a thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution. Thus, the battery device 20, i.e., the wound electrode body, is fabricated, and the battery device 20 is sealed in the outer package film 10 having the pouch shape. As a result, the secondary battery is assembled.

The secondary battery after being assembled is charged and discharged. Various conditions including, for example, an environment temperature, the number of times of charging and discharging (the number of cycles), and charging and discharging conditions may be set as desired. As a result, a film is formed on the surface of each of the positive electrode 21 and the negative electrode 22, and the state of the secondary battery is electrochemically stabilized. The secondary battery is thus completed.

The secondary battery includes the negative electrode 22 having a configuration similar to that of the negative electrode described above. Thus, the collapse of the negative electrode active material layer 120 and the decomposition reaction of the electrolytic solution are suppressed while the ion conductivity of lithium is secured. Accordingly, it is possible to achieve a superior low-temperature cyclability characteristic and a superior electric resistance characteristic.

In particular, the secondary battery may include a lithium-ion secondary battery. This makes it possible to obtain a sufficient battery capacity stably through the use of insertion and extraction of lithium. Accordingly, it is possible to achieve higher effects.

Other action and effects of the secondary battery are similar to those of the negative electrode described above.

Next, a description is given of modifications of each of the negative electrode and the secondary battery described above according to an embodiment.

The configuration of each of the negative electrode and the secondary battery is appropriately modifiable as described below. Note that any two or more of the following series of modifications may be combined with each other.

In an embodiment, the negative electrode does not include the covering part 121Y. Thus, the polyrotaxane and the organic fiber compound are each dispersed in the negative electrode active material layer 120. In an embodiment, the negative electrode active material particle 121 of the negative electrode includes the covering part 121Y. The covering part 121Y includes the polyrotaxane and the organic fiber compound. Thus, the polyrotaxane and the organic fiber compound are each localized on the surface of the center part 121X in the negative electrode active material layer 120.

However, the configurations of the negative electrode may be combined with each other according to an embodiment. For example, the negative electrode active material layer 120 may include the polyrotaxane and the organic fiber compound together with the negative electrode active material particles 121 (the center part 121X and the covering part 121Y). That is, in the negative electrode active material layer 120, the polyrotaxane and the organic fiber compound may each be localized on the surface of the center part 121X, and the polyrotaxane and the organic fiber compound may each be dispersed around the negative electrode active material particles 121.

In this case also, the synergistic interaction between the polyrotaxane and the organic fiber compound suppresses the collapse of the negative electrode active material layer 120 and the decomposition reaction of the electrolytic solution while securing the ion conductivity of lithium, and similar effects are therefore obtainable.

The separator 23 that is a porous film is used. However, although not specifically illustrated here, a separator of a stacked type including a polymer compound layer may be used.

For example, the separator of the stacked type includes a porous film having two opposed surfaces and the polymer compound layer disposed on one of or each of the two opposed surfaces of the porous film. A reason for this is that adherence of the separator to each of the positive electrode 21 and the negative electrode 22 improves, which suppresses winding displacement of the battery device 20. This helps to prevent the secondary battery from easily swelling even if the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include any one or more kinds of insulating particles. A reason for this is that the insulating particles promote heat dissipation upon heat generation by the secondary battery, thus improving safety or heat resistance of the secondary battery. The insulating particles include any one or more of materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

In fabricating the separator of the stacked type, a precursor solution including, without limitation, the polymer compound and a solvent is prepared, following which the precursor solution is applied on one of or each of the two opposed surfaces of the porous film. In this case, the porous film may be immersed in the precursor solution instead of applying the precursor solution on the porous film. The insulating particles may be added to the precursor solution.

When the separator of the stacked type is used also, lithium ions are movable between the positive electrode 21 and the negative electrode 22, and similar effects are therefore obtainable. In this case, in particular, the safety of the secondary battery is improved as described above. Accordingly, it is possible to achieve higher effects.

The electrolytic solution that is a liquid electrolyte is used. However, although not specifically illustrated here, an electrolyte layer that is a gel electrolyte may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23. Note that the electrolyte layer may be interposed only between the positive electrode 21 and the separator 23, or may be interposed only between the negative electrode 22 and the separator 23.

The electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium ions are movable between the positive electrode 21 and the negative electrode 22 via the electrolyte layer, and similar effects are therefore obtainable. In this case, in particular, the leakage of the electrolytic solution is prevented as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery pack may include a single battery, or may include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

FIG. 5 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 5, the battery pack includes an electric power source 51 and a circuit board 52. The circuit board 52 is coupled to the electric power source 51 and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to an external power source via the positive electrode terminal 53 and the negative electrode terminal 54, and is thus chargeable and dischargeable. The circuit board 52 includes a controller 56, a switch 57, a thermosensitive resistive device (what is called a PTC device) 58, and a temperature detector 59. However, the PTC device 58 may be omitted.

The controller 56 includes, for example, a central processing unit (CPU) and a memory and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55 and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 4 and Comparative Examples 1 to 5

Secondary batteries were fabricated, following which the secondary batteries were each evaluated for a characteristic as described below.

### [Fabrication of Secondary Battery]

The secondary batteries (the lithium-ion secondary batteries of the laminated-film type) illustrated in FIGS. 3 and 4 were fabricated in accordance with the following procedure.

### (Fabrication of Positive Electrode)

First, 95 parts by mass of the positive electrode active material (lithium cobalt oxide (LiCoO₂) that was the lithium-containing compound (an oxide)), 3 parts by mass of the positive electrode binder (polyvinylidene difluoride), and 2 parts by mass of the positive electrode conductor (Ketjen black that was an amorphous carbon material) were mixed with each other to thereby obtain a positive electrode mixture. Thereafter, the positive electrode mixture was put into a solvent (N-methyl-2-pyrrolidone that was an organic solvent), following which the solvent was stirred to thereby prepare a positive electrode mixture slurry in paste form.

Thereafter, the positive electrode mixture slurry was applied on the two opposed surfaces of the positive electrode current collector 21A (an aluminum foil having a thickness of 10 μm) by means of a coating apparatus, following which the applied positive electrode mixture slurry was dried to thereby form the positive electrode active material layers 21B. Lastly, the positive electrode active material layers 21B were compression-molded by means of a roll pressing machine, following which the positive electrode current collector 21A on which the positive electrode active material layers 21B were formed was cut into a band shape (having a width of 70 mm and a length of 800 mm). The positive electrode 21 was thus fabricated.

### (Fabrication of Negative Electrode)

Here, the negative electrodes 22 having two kinds of configurations (a dispersion type and a covering type) were fabricated.

In fabricating the negative electrode 22 of the dispersion type, first, 65.4 parts by mass of the negative electrode active material (mesocarbon microbead (MCMB) that was the carbon material), 30 parts by mass of another negative electrode active material (silicon oxide (SiO) that was the metal-based material), 3 parts by mass of the negative electrode binder (polyvinylidene difluoride), 1 part by mass of the negative electrode conductor (carbon nanotube), 0.3 parts by mass of the polyrotaxane, and 0.3 parts by mass of the organic fiber compound were mixed with each other to thereby form a negative electrode mixture.

Used as the polyrotaxane was SeRM Super Polymer SH2400P (CD/PEG) available from ASM Inc. The polyrotaxane included cyclodextrin as the cyclic molecule and included polyethylene glycol having an adamantyl group at each of opposite ends as the linear molecule. The linear molecule had a molecular weight of 20,000 and the polyrotaxane had a total molecular weight of 400,000.

Used as the organic fiber compound were cellulose (CEL), chitin (CHN), and chitosan (CHT).

Thereafter, the negative electrode mixture was put into a solvent (N-methyl-2-pyrrolidone that was an organic solvent), following which the solvent with the negative electrode mixture put thereinto was stirred using a planetary centrifugal mixer to thereby prepare a negative electrode mixture slurry in paste form. Thereafter, the negative electrode mixture slurry was applied on the two opposed surfaces of the negative electrode current collector 22A (a copper foil having a thickness of 8 μm) by means of a coating apparatus, following which the applied negative electrode mixture slurry was dried by hot air to thereby form the negative electrode active material layers 22B.

Lastly, the negative electrode active material layers 22B were compression-molded by means of a roll pressing machine, following which the negative electrode current collector 22A on which the negative electrode active material layers 22B were formed was cut into a band shape (having a width of 72 mm and a length of 810 mm). The negative electrode 22 of the dispersion type was thus fabricated.

In fabricating the negative electrode 22 of the covering type, first, 98 parts by mass of the metal-based material in powder form (silicon oxide (SiO)), 1 part by mass of the polyrotaxane (CD/PEG), and 1 part by mass of the organic fiber compound (CEL) were mixed with each other to thereby obtain a mixture.

Thereafter, the mixture was put into a solvent (pure water that was an aqueous solvent), following which the solvent with the mixture put thereinto was stirred to thereby prepare a mixed solution. Thereafter, the mixed solution was sprayed using a spray dryer, following which the sprayed matter was dried. This formed the covering part 121Y including the polyrotaxane and the organic fiber compound on the surface of the center part 121X including the metal-based material. Thus, the negative electrode active material particles 121 were obtained.

Thereafter, 65.4 parts by mass of the negative electrode active material (the MCMB), 30.6 parts by mass of another negative electrode active material (the negative electrode active material particles 121), 3 parts by mass of the negative electrode binder (polyvinylidene difluoride), and 1 part by mass of the negative electrode conductor (carbon nanotube) were mixed with each other to thereby obtain a negative electrode mixture. Thereafter, the negative electrode mixture was put into a solvent (N-methyl-2-pyrrolidone that was an organic solvent), following which the solvent with the negative electrode mixture put thereinto was stirred using a planetary centrifugal mixer to thereby prepare a negative electrode mixture slurry in paste form.

Thereafter, by a procedure similar to that in the case where the negative electrode 22 of the dispersion type was fabricated, the negative electrode active material layers 22B were formed using the negative electrode mixture slurry and the negative electrode active material layers 22B were compression-molded, following which the negative electrode current collector 22A on which the negative electrode active material layers 22B were formed was cut into a band shape. The negative electrode 22 of the covering type was thus fabricated.

Note that, for comparison, the negative electrode 22 was fabricated by a similar procedure except that either the polyrotaxane or the organic fiber compound was not used or neither the polyrotaxane nor the organic fiber compound was used. In this case, the amount of the negative electrode active material (the carbon material) was adjusted in accordance with the presence or absence of each of the polyrotaxane and the organic fiber compound.

### (Preparation of Electrolytic Solution)

The electrolyte salt (lithium hexafluorophosphate (LiPF₆) that was a lithium salt) was added to a solvent (ethylene carbonate that was a cyclic carbonic acid ester and ethyl methyl carbonate that was a chain carbonate ester), following which the solvent with the electrolyte salt added thereto was stirred. In this case, a mixture ratio (a mass ratio) between the cyclic carbonic acid ester and the chain carbonic acid ester in the solvent was set to 50:50, and a content of the electrolyte salt was set to 1 mol/l (=1 mol/dm³) with respect to the solvent. In this manner, the electrolytic solution was prepared.

### (Assembly of Secondary Battery)

First, the positive electrode lead 31 (an aluminum foil) was welded to the positive electrode current collector 21A of the positive electrode 21, and the negative electrode lead 32 (a copper foil) was welded to the negative electrode current collector 22A of the negative electrode 22.

Thereafter, the positive electrode 21 and the negative electrode 22 were stacked on each other with the separator 23 (a fine porous polyethylene film having a thickness of 25 μm) interposed therebetween, following which the stack of the positive electrode 21, the negative electrode 22, and the separator 23 was wound to thereby fabricate a wound body. Thereafter, the wound body was pressed by means of a pressing machine, and was thereby shaped into an elongated shape.

Thereafter, the outer package film 10 was so folded as to sandwich the wound body contained inside the depression part 10U. As the outer package film 10, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from an inner side. Thereafter, the outer edge parts of two sides of the fusion-bonding layer were thermal-fusion-bonded to each other to thereby allow the wound body to be contained inside the outer package film 10 having the pouch shape.

Lastly, the electrolytic solution was injected into the outer package film 10 having the pouch shape, following which the outer edge parts of the remaining one side of the fusion-bonding layer were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32.

In this manner, the wound body was impregnated with the electrolytic solution, and the battery device 20 was thus fabricated. Accordingly, the battery device 20 was sealed in the outer package film 10. As a result, the secondary battery was assembled.

### (Stabilization of Secondary Battery)

The secondary battery was charged and discharged for one cycle in an ambient-temperature environment (at a temperature of 23° C.). Upon the charging, the secondary battery was charged with a constant current of 0.2 C until a voltage reached 4.4 V, and was thereafter charged with a constant voltage of 4.4 V until a current reached 0.025 C. Upon the discharging, the secondary battery was discharged with a constant current of 0.2 C until the voltage reached 3.0 V. Note that 0.2 C was a value of a current that caused a battery capacity (a theoretical capacity) to be completely discharged in 5 hours, and 0.025 C was a value of a current that caused the battery capacity to be completely discharged in 40 hours.

As a result, a film was formed on the surface of each of the positive electrode 21 and the negative electrode 22, and the secondary battery was electrochemically stabilized. The secondary battery was thus completed.

### (Design of Secondary Battery)

In fabricating the secondary battery (the lithium-ion secondary battery of the laminated-film type), a capacity ratio was designed in accordance with the following procedure.

First, the positive electrode 21 was fabricated by a similar procedure except that the positive electrode active material layer 21B was formed only on one of the two opposed surfaces of the positive electrode current collector 21A. In addition, the negative electrode 22 was fabricated by a similar procedure except that the negative electrode active material layer 22B was formed only on one of the two opposed surfaces of the negative electrode current collector 22A.

Thereafter, a test secondary battery (an unillustrated secondary battery of a coin type) was fabricated using the positive electrode 21 as a test electrode and a lithium metal plate as a counter electrode. In addition, a test secondary battery (an unillustrated secondary battery of the coin type) was fabricated using the negative electrode 22 as the test electrode and a lithium metal plate as the counter electrode.

Thereafter, the test secondary battery including the positive electrode 21 as the test electrode was charged to measure an electrical capacity, following which a charge capacity of the positive electrode 21 per thickness of the positive electrode active material layer 21B was calculated based on the measured electrical capacity and the thickness of the positive electrode active material layer 21B. Upon the charging, the test secondary battery was charged with a constant current of 0.1 C until a voltage reached 4.45 V, and was thereafter charged with a constant voltage of 4.45 V until a current decreased to 1/10. Note that 0.1 C was a value of a current that caused the battery capacity to be completely discharged in 10 hours.

Thereafter, the test secondary battery including the negative electrode 22 as the test electrode was charged to measure an electrical capacity, following which a charge capacity of the negative electrode 22 per thickness of the negative electrode active material layer 22B was calculated based on the measured electrical capacity and the thickness of the negative electrode active material layer 22B. Upon the charging, the test secondary battery was charged with a constant current of 0.1 C until a voltage reached 0 V, and was thereafter charged with a constant voltage of 0 V until a current decreased to 1/10.

Lastly, the capacity ratio was calculated based on the charge capacity of the positive electrode 21 and the charge capacity of the negative electrode 22. The capacity ratio was calculated based on the following calculation expression: capacity ratio=charge capacity of positive electrode 21/charge capacity of negative electrode 22.

In fabricating the above-described secondary battery (the lithium-ion secondary battery of the laminated-film type), a concentration and an application speed of each of the positive electrode mixture slurry and the negative electrode mixture slurry were so adjusted that the capacity ratio became 0.9.

### [Characteristic Evaluation of Secondary Battery]

Evaluation of each of a low-temperature cyclability characteristic and a load characteristic by the following procedure revealed the results presented in Table 1.

### (Low-Temperature Cyclability Characteristic)

First, the secondary battery was charged and discharged in a low-temperature environment (at a temperature of 5° C.) to thereby measure a discharge capacity (a first-cycle discharge capacity). Thereafter, the secondary battery was repeatedly charged and discharged in the same environment until the number of cycles reached 100 to thereby measure the discharge capacity (a 100th-cycle discharge capacity). Lastly, a cycle retention rate as an index for evaluating the low-temperature cyclability characteristic was calculated based on the following calculation expression: cycle retention rate (%)=(100th-cycle discharge capacity/first-cycle discharge capacity)×100. Charging and discharging conditions were similar to those in the case of stabilizing the secondary battery.

Note that values of the cycle retention rate given in Table 1 were values normalized with respect to the value of the cycle retention rate of Comparative example 1 that included neither the polyrotaxane nor the organic fiber compound assumed to be 100.00. In this case, the values of the cycle retention rate were values rounded off to two decimal places.

### (Load Characteristic)

First, the secondary battery was charged and discharged in an ambient temperature environment (at a temperature of 23° C.) to thereby measure the discharge capacity (a first-cycle discharge capacity). Charging and discharging conditions were similar to those in the case of stabilizing the secondary battery.

Thereafter, the secondary battery was charged and discharged in the same environment to thereby measure the discharge capacity (a second-cycle discharge capacity). Charging and discharging conditions were similar to those in the first cycle except that the current at the time of the discharging was changed to 2 C. Note that 2 C was a value of a current that caused the battery capacity to be completely discharged in 0.5 hours.

Lastly, a load retention rate as an index for evaluating the load characteristic was calculated based on the following calculation expression: load retention rate (%)=(second-cycle discharge capacity/first-cycle discharge capacity)×100.

Note that, as with the values of the cycle retention rate described above, values of the load retention rate given in Table 1 were values normalized with respect to the value of the load retention rate of Comparative example 1 assumed to be 100.00, and were values rounded off to two decimal places.

TABLE 1

| | | Carbon | | Metal-based | | | | Organic fiber | | Cycle | Load |
|---|---|---|---|---|---|---|---|---|---|---|---|
| | | material | | material | | Polyrotaxane | | compound | | retention | retention |
| | | | Content | | Content | | Content | | Content | rate | rate |
| | Configuration | Kind | (wt %) | Kind | (wt %) | Kind | (wt %) | Kind | (wt %) | (%) | (%) |
| Example 1 | Covering type | MCMB | 65.4 | SiO | 30 | CD/PEG | 0.3 | CEL | 0.3 | 107.50 | 101.60 |
| Example 2 | Covering type | MCMB | 65.4 | SiO | 30 | CD/PEG | 0.3 | CHN | 0.3 | 106.25 | 101.06 |
| Example 3 | Covering type | MCMB | 65.4 | SiO | 30 | CD/PEG | 0.3 | CHT | 0.3 | 105.63 | 100.53 |
| Example 4 | Dispersion type | MCMB | 65.4 | SiO | 30 | CD/PEG | 0.3 | CEL | 0.3 | 106.00 | 101.00 |
| Comparative | — | MCMB | 66.0 | SiO | 30 | — | — | — | — | 100.00 | 100.00 |
| example 1 | | | | | | | | | | | |
| Comparative | Covering type | MCMB | 65.7 | SiO | 30 | CD/PEG | 0.3 | — | — | 97.50 | 99.47 |
| example 2 | | | | | | | | | | | |
| Comparative | Covering type | MCMB | 65.4 | SiO | 30 | CD/PEG | 0.6 | — | — | 93.75 | 97.87 |
| example 3 | | | | | | | | | | | |
| Comparative | Covering type | MCMB | 65.7 | SiO | 30 | — | — | CEL | 0.3 | 101.25 | 100.00 |
| example 4 | | | | | | | | | | | |
| Comparative | Covering type | MCMB | 65.4 | SiO | 30 | — | — | CEL | 0.6 | 102.50 | 100.00 |
| example 5 | | | | | | | | | | | |

As indicated in Table 1, the cycle retention rate and the load retention rate each varied greatly depending on the configuration of the negative electrode 22. Hereinafter, each of the cycle retention rate and the load retention rate of Comparative example 1 that included neither the polyrotaxane nor the organic fiber compound served as a comparative reference.

When only the polyrotaxane was used (Comparative examples 2 and 3), the cycle retention rate greatly decreased and the load retention rate decreased. When only the organic fiber compound was used (Comparative examples 4 and 5), the cycle retention rate slightly increased but the load retention rate remained at the same level.

According to these results, it is expected that using both the polyrotaxane and the organic fiber compound will reduce the cycle retention rate and the loading retention rate.

However, in practice, when both the polyrotaxane and the organic fiber compound were used (Examples 1 to 4), the synergistic interaction between the polyrotaxane and the organic fiber compound resulted in contrary to the expectation described above. Specifically, the cycle retention rate greatly increased and the load retention rate increased, regardless of the configuration (the dispersion type and the covering type) of the negative electrode 22.

Based upon the results presented in Table 1, when the negative electrode 22 included the polyrotaxane and the organic fiber compound, a high cycle retention rate and a high load retention rate were obtained. The secondary battery therefore achieved a superior low-temperature cyclability characteristic and a superior load characteristic.

Although the present technology has been described above with reference to one or more embodiments including Examples, the configuration of the present technology is not limited thereto, and is therefore modifiable in a variety of suitable ways.

For example, the description has been given of the case where the secondary battery has a battery structure of the laminated-film type. However, the battery structure of the secondary battery is not particularly limited, and may be, for example, of a cylindrical type, a prismatic type, a coin type, or a button type.

Further, the description has been given of the case where the battery device has a device structure of a wound type. However, the device structure of the battery device is not particularly limited, and may be, for example, of a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the negative electrode includes a polyrotaxane and an organic fiber compound.

2. The secondary battery according to claim 1, wherein the organic fiber compound includes at least one of cellulose, chitin, or chitosan.

3. The secondary battery according to claim 1, wherein
the polyrotaxane includes a cyclic molecule and a linear molecule penetrating the cyclic molecule,
the linear molecule has an end group that serves as a steric hindrance to the cyclic molecule at each of opposite ends,
the cyclic molecule includes at least one of a cyclodextrin, a crown ether, a thiocrown ether, a cyclophane, a calixarene, a thiocalixarene, a cucurbituril, a pillararene, or a cyclic amide,
the linear molecule includes at least one of polyethylene glycol, polyoxymethylene, polypropylene oxide, polyvinyl alcohol, polyvinylidene difluoride, a straight-chain alkane, an amide, or ammonium, and
the end group includes at least one of a dinitrophenyl group, a cyclodextrin group, an adamantyl group, a trityl group, a fluoresceinyl group, a pyrenyl group, or an anthracenyl group.

4. The secondary battery according to claim 1, wherein
the negative electrode includes a negative electrode active material layer, and
the negative electrode active material layer includes a negative electrode active material which an electrode reactant is insertable into and extractable from, the polyrotaxane, and the organic fiber compound.

5. The secondary battery according to claim 1, wherein
the negative electrode includes a negative electrode active material which an electrode reactant is insertable into and extractable from,
the negative electrode active material includes a center part which the electrode reactant is insertable into and extractable from, and a covering part covering a surface of the center part, and
the covering part includes the polyrotaxane and the organic fiber compound.

6. The secondary battery according to claim 1, wherein the secondary battery comprises a lithium-ion secondary battery.

7. A negative electrode for a secondary battery, the negative electrode comprising a polyrotaxane and an organic fiber compound.
